(19) United States
(12) Patent Application Publication
(10) Pub. No.: US 2014/0001145 A1
(43) Pub. Date: Jan. 2, 2014

(54) METHOD OF FORMING A CAPACITOR STRUCTURE, AND A SILICON ETCHING LIQUID USED IN THIS METHOD

(71) Applicant: FUJIFILM Corporation, Tokyo (JP)

(72) Inventors: Atsushi MIZUTANI, Haibara-gun (JP); Tadashi INABA, Haibara-gun (JP); Akiko KOYAMA, Haibara-gun (JP)

(73) Assignee: FUJIFILM Corporation, Tokyo (JP)

(21) Appl. No.: 14/016,854

(22) Filed: Sep. 3, 2013

Related U.S. Application Data
(63) Continuation of application No. PCT/JP2012/055726, filed on Feb. 28, 2012.

(30) Foreign Application Priority Data
Mar. 4, 2011 (JP) 2011-048281
Feb. 27, 2012 (JP) 2012-040234

(51) Int. Cl. H01G 13/00; C09K 13/02; C09K 13/00

(52) U.S. Cl. CPC H01G 13/00; C09K 13/00; C09K 13/02
USPC 216/6; 252/79.1; 252/79.5

(57) ABSTRACT

A method of forming a capacitor structure, which comprises: applying a silicon etching liquid which contains an alkali compound and a hydroxylamine compound in combination, with the pH adjusted to 11 or more, to a polycrystalline silicon film or an amorphous silicon film, removing a part or all of the polycrystalline silicon film or amorphous silicon film, and forming concave and convex shapes that constitute a capacitor.

### TECHNICAL FIELD

The present invention relates to a method of forming a capacitor structure, and a silicon etching liquid used in this method.

### BACKGROUND ART

A concave type structure has been conventionally employed for the capacitor structure in a dynamic random access memory (DRAM). In this structure, a lower electrode film is formed inside a cylinder bore, and only the inner surface is made to function as an electrode. According to this structure, the area occupied by the capacitor can be certainly made small, but the diameter of the cylinder bore is also necessarily decreased. On the other hand, it is necessary to secure the capacitance needed for the device operation of the DRAM. In order to satisfy these two requirements, the depth of the cylinder bore is further deepened, so that it is becoming more difficult to cope with the production of capacitors in terms of microprocessing technology. In view of such circumstances, there has been suggested a crown type capacitor which uses not only the inner side but also the outer side of the lower electrode in the cylinder structure, so that the aspect ratio of the capacitor can be reduced (see, for example, Patent Literature 1).

As such, attempts have been made to control the aspect ratio of the capacitor structure, but the process itself of forming a fine cylinder structure or a bore therein by processing with high accuracy is not that simple. Usually, this process is carried out by wet etching. That is, in order to leave a tubular structure having a cylindrical wall with a nanometer to submicrometer-sized depth in a silicon substrate, the material inside and outside the tubular structure should be removed using an etching liquid. Particularly, the removal of material inside the cylinder bore must be removed in a manner such that the material is scraped out from an enclosed space, and this process poses difficulties as a processing carried out by wet etching. In view of emphasizing the processability, it can also be contemplated to apply a solvent having a high etching power; however, there is a concern that the electrode or other elements may be corroded under the action of such a solvent. Furthermore, there is a tendency that in order to make the aspect ratio higher, the material of the filler is changed from SiO₂ to polycrystalline silicon or amorphous silicon, and it is now necessary to enable satisfactory etching to cope with this tendency.

### CITATION LIST

### Patent Literatures

Patent Literature 1: JP-A-2010-199136 (“JP-A” means unexamined published Japanese patent application)

### DISCLOSURE OF INVENTION

### Technical Problem

In regard to an etching liquid which enables satisfactory removal of silicon or the like from cylinder bores as well as from the capacitor structure that is recently employed such as described above, research and development has not yet been sufficiently carried out. Particularly, the inventors of the present invention conceived that upon forming a number of capacitor structures, it is important to perform etching in the edges and the center of a wafer in a uniform and well-balanced manner as far as possible, from the viewpoint of enhancing the manufacturing quality when the wafer is fabricated into elements. Further, the inventors conducted an investigation on the etching properties of amorphous silicon or polycrystalline silicon in particular, which are increasingly used in a wider variety of applications in recent years.

Thus, it is an object of the present invention to provide a silicon etching liquid which is capable of removing the material of amorphous silicon or polycrystalline silicon accurately and efficiently around an area where a capacitor structure having concavities and convexities is to be formed, and is capable of etching in a well-balanced manner between the center and the edges of a wafer on which a number of capacitor structures are formed, and a method of forming a capacitor structure using this silicon etching liquid. Furthermore, it is an object of the invention to provide a silicon etching liquid for polycrystalline silicon films or amorphous silicon films, which has excellent storage properties, and can accurately cope with the alteration or extension of the time of application in the actual field of capacitor production, thereby contributing to an improvement in productivity, and a method of forming a capacitor structure using this silicon etching liquid.

### Solution to Problem

The problems of the present invention can be solved by the following means.

(1) A method of forming a capacitor structure, which comprises: applying a silicon etching liquid which contains an alkali compound and a hydroxylamine compound in combination, with the pH adjusted to 11 or more, to a polycrystalline silicon film or an amorphous silicon film, removing a part or all of the polycrystalline silicon film or amorphous silicon film, and forming concave and convex shapes that constitute a capacitor.
(2) The method as set forth in the item (1), wherein the area with the concave and convex shapes has a cylinder bore that is formed as a result of removal of the silicon film using the silicon etching liquid.
(3) The method as set forth in the item (1) or (2), further comprising a step of removing an oxide film formed on the silicon film before the silicon etching liquid is applied.
(4) The method as set forth in the item (2) or (3), wherein the area with the concave and convex shapes that constitute the capacitor structure includes TiN, and wherein the cylinder bore has an aspect ratio of 15 or more.
(5) The method as set forth in any one of the items (1) to (4), wherein the concentration of the alkali compound is 3 to 25 mass %.
(6) The method as set forth in any one of the items (1) to (5), wherein the concentration of the hydroxylamine compound is 0.1 to 15 mass %.
(7) The method as set forth in any one of the items (1) to (6), wherein the silicon etching liquid further contains alcohol compounds, sulfoxide compounds or ether compounds.
(8) A silicon etching liquid for preparing a capacitor structure by removing a part or all of a polycrystalline silicon film or an amorphous silicon film to shape concave and convex shapes that constitute a capacitor, which comprises an alkali compound and a hydroxylamine compound in combination, with the pH adjusted to 11 or more.
(9) The silicon etching liquid as set forth in the item (8), wherein the object of application is a polycrystalline silicon film.
(10) The silicon etching liquid as set forth in the item (8), wherein the object of application is an amorphous silicon film.
(11) The silicon etching liquid as set forth in any one of the items (8) to (10), wherein the area with the concave and convex shapes that constitute the capacitor structure includes TiN, and has a cylinder bore that is formed as a result of removal of the silicon film using the silicon etching liquid.
(12) The silicon etching liquid as set forth in the item (11), wherein the cylinder bore has an aspect ratio of 15 or more.
(13) The silicon etching liquid as set forth in any one of the items (8) to (12), wherein the concentration of the alkali compound is 3 to 25 mass %.
(14) The silicon etching liquid as set forth in any one of the items (8) to (13), wherein the concentration of the hydroxylamine compound is 0.1 to 15 mass %.
(15) The silicon etching liquid as set forth in any one of the items (8) to (14), wherein the alkali compound is one or more compounds selected from quaternary ammonium hydroxides, ammonia and potassium hydroxide.
(16) The silicon etching liquid as set forth in any one of the items (8) to (15), wherein the alkali compound is a quaternary ammonium hydroxide.
(17) The silicon etching liquid as set forth in any one of the items (8) to (16), wherein the alkali compound is tetramethylammonium hydroxide.
(18) The silicon etching liquid as set forth in any one of the items (8) to (17), wherein the silicon etching liquid is used immediately after a treatment for removing the oxide film formed on the surface of the silicon film.
(19) The silicon etching liquid as set forth in any one of the items (8) to (18), wherein the silicon etching liquid further contains alcohol compound, sulfoxide compound or ether compound.

### Advantageous Effects of Invention

According to the present invention, the material of amorphous silicon, polycrystalline silicon or the like in an area where a capacitor structure having concavities and convexities can be accurately and efficiently removed, and etching can be achieved in a well-balanced manner between the center and the edges of a wafer on which a number of capacitor structures are formed. Furthermore, the present invention provides an excellent operating effect that if necessary, the present invention can even cope with a capacitor structure constituted of electrodes having a cylindrical structure, and can selectively remove a polycrystalline silicon film or an amorphous silicon film inside a cylinder bore. Also, the silicon etching liquid of the present invention has excellent storage properties, and can accurately cope with the alteration or extension of the time of application in the actual field of capacitor production, thereby contributing to an improvement in productivity.

Other and further features and advantages of the invention will appear more fully from the following description, appropriately referring to the accompanying drawings.

### BRIEF DESCRIPTION OF THE DRAWINGS

FIG. 1 is a cross-sectional view schematically showing an example of the production step for the capacitor structure that is applied to the present invention

FIG. 2 is a cross-sectional view schematically showing an example of the production step for the capacitor structure that is applied to the present invention (a continuation of FIG. 1).

FIG. 3 is a cross-sectional view schematically showing an example of the production step for the capacitor structure that is applied to the present invention (a continuation of FIG. 2).

FIG. 4 is a cross-sectional view schematically showing an example of the production step for the capacitor structure that is applied to the present invention (a continuation of FIG. 3).

FIG. 5 is a cross-sectional view schematically showing another example of the capacitor structure that is applied to the present invention.

### MODE FOR CARRYING OUT THE INVENTION

### [Formation of Capacitor Structure]

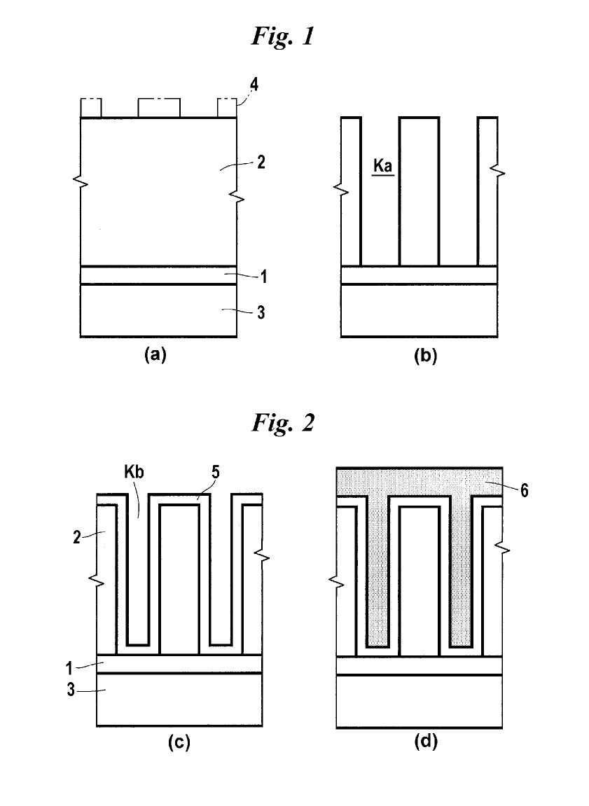

First, prior to the description of an etching liquid according to the present invention, a production example for a capacitor structure that can be suitably employed in the present invention will be described with reference to FIGS. 1 to 5.

### (Step a)

In the production example of the present embodiment, a first insulating film 1 and a second insulating film 2 are formed on a silicon wafer 3. The first insulating film 1 is a film which serves as an etching stopper film at the time of boring a cylinder bore, and has an etching rate ratio with the second insulating film 2 in an anisotropic dry etching process. An example of the first insulating film 1 may be a nitride film formed by a low pressure chemical vapor deposition (LP-CVD) process. On the other hand, the second insulating film 2 may be a polycrystalline silicon film or an amorphous silicon film. Although not depicted, a protective film may also be provided on the silicon wafer 3.

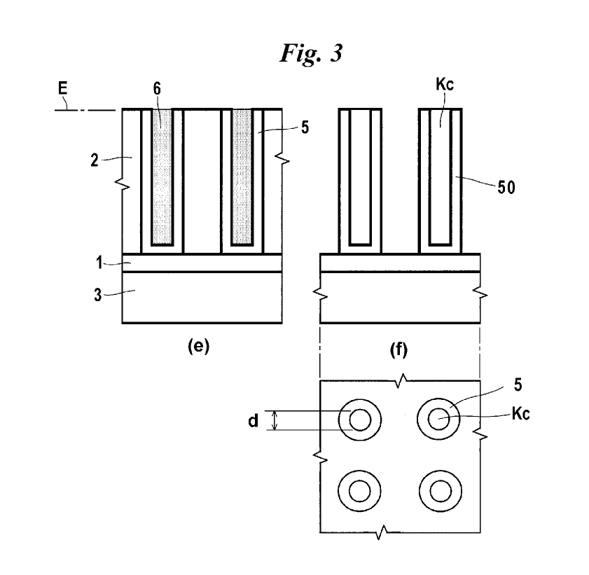

The silicon wafer 3 is shown in a significantly simplified form and is shown to be composed of a single layer; however, a predetermined a circuit structure is usually formed thereon. For example, a separation insulating film, a gate oxide film, a gate electrode, a diffusion layer region, a polysilicon plug, a silicon oxide film, a silicon nitride film, a bit line, a metal plug, a nitride film, a plasma oxide film, a borophosphosilicate glass (BPSG) film or the like may be used on the silicon wafer 3 (see, for example, Patent Literature 1). In FIGS. 1 to 5, although not particularly indicated with hatched areas, the views show the cross-sections of various members (the view in the lower part of FIG. 3(f) is a plan view). Although indicated with a structure floating through a capacitor structure 10 to a lower electrode 50, the structure can be a substrate structure secured continuity as needed.

### (Step b)

Subsequently, a photoresist 4 is patterned by performing a photolithographic process, and a bore is formed by anisotropic dry etching (opening Ka). In regard to the photoresist 4 and the technique of dry etching in this case, conventional materials or methods that are applied to this type of product may be applied.

### (Step c), (Step d)

Furthermore, after a bore is formed, an electrode protective film (not depicted in the FIGS.) is formed along the wall surfaces of the opening Ka. The electrode protective film is desirably an insulating film which has a sufficient etching rate ratio with respect to a wet etching liquid that is used for the removal of a silicon material at the time of capacitor structure formation. It is more desirable that the electrode protective film is a film that may be uniformly formed over the entire wall surfaces of the cylinder bore Ka. Examples thereof include a nitride film or a tantalum pentoxide (Ta₂O₅) film formed by an atomic layer deposition (ALD) method. After the electrode protective film is formed, the electrode protective film is removed by isotropic etching. Subsequently, a conductive film 5 and an embedded film 6 for protecting the conductive film 5 (for example, a polycrystalline silicon film or an amorphous silicon film) are formed thereon in this order.

### (Step e)

After the embedded film 6 is formed, portions of the embedded film 6 and the conductive film 5 (FIGS. 2 and 3) on the wafer surface are removed by chemical-mechanical planarization (CMP), until the etch-back line E is exposed. Here, the second insulating film 2 and the embedded film 6 are removed by wet etching process. In the present invention, this step is important, and the etching liquid according to the present invention that will be described below exhibits excellent effects in this step. After this step is completed, a lower electrode (cylinder wall) 50 of a capacitor having a cylinder bore Kc is formed (FIG. 3).

### (Step f)

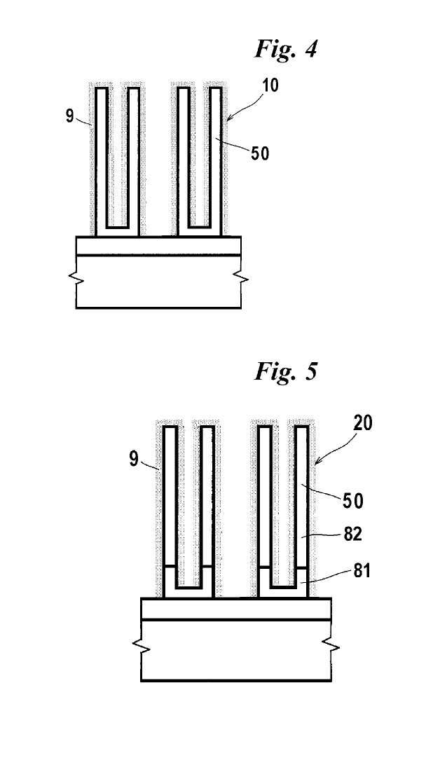

After the formation of the lower electrode 50 of the capacitor formed as described above, a capacitive insulating film 9 is formed, and then the formation of a plate electrode (upper electrode) (not depicted) is subsequently implemented. Thus, a capacitor structure 10 can be formed. Furthermore, the capacitor structure as used herein may be a capacitor itself, or may be a structural unit constituting a portion of a capacitor. In the example shown in FIG. 4, the capacitor structure 10 is illustrated to be composed of a lower electrode 50 and a capacitive insulating film 9.

FIG. 5 shows a modification example of the capacitor structure of the embodiment described above. In this example, a bottom area 81 and a main area 82 of the lower electrode (cylinder structure) are formed from different materials. For example, an example may be contemplated, in which the bottom area 81 is formed of Si₃N₄ and the main area 82 is formed of TiN.

### [Silicon Etching Liquid]

Next, a preferred embodiment of the silicon etching liquid of the present invention that can be very effectively used in the wet etching process described in connection with the Step e will be described. In regard to the etching liquid of the present embodiment, when a combination of a particular alkali compound and a particular hydroxylamine compound is applied, the removal of a polycrystalline silicon film or an amorphous silicon film, which is related to the formation of a capacitor structure having concave and convex shapes such as described above, can be accurately carried out without damaging members such as electrodes. The specific reason for this is not clearly known in some aspects, but is speculated to be as follows.

Hydroxylamines are generally known to form a complex with silicon (Wannagat, U., and Pump, J., Monatsh. Chem., 94, 141 (1963)). It is also known that alkali compounds dissolve in silicon while silanolizing silicon. In regard to the silicon etching liquid of the present invention, it is speculated that when an alkali compound and a hydroxylamine compound are used in combination, not any one of the reactions described above occurs preferentially, but these two reactions proceed simultaneously, and thereby the etching rate can be increased. It is not known if such an operating mechanism would work with monocrystal silicon; however, it is construed that such an operating mechanism is effectively manifested in polycrystalline silicon or amorphous silicon.

In addition, the term liquid combining particular agents as used herein means a liquid composition containing the relevant agents, and also means to include a kit which is used after mixing the respective agents or liquids containing those agents before use. Furthermore, the term silicon substrate is used to mean not only a silicon wafer, but also a circuit structure provided thereon with a circuit structure as a whole. The silicon substrate member refers to a member constituting the silicon substrate defined above, and such a member may be formed of a single material or may be formed from plural materials.

### (Hydroxylamine Compound)

The etching liquid of the present embodiment contains hydroxyl amine compound. Here, the term hydroxylamine compound is used to mean the relevant compound as well as a salt thereof, an ion thereof or the like. Typically, the hydroxylamine compound means the relevant compound itself and/or a salt thereof. Therefore, when the term hydroxylamine compound is used, it is implied that the compound includes hydroxylammonium ion, hydroxylamine, and/or a salt thereof, and typically, the hydroxylamine compound means hydroxylamine and/or a salt thereof

Examples of the salt of a hydroxylamine that is used to form the etching liquid of the present embodiment include hydroxylamine nitrate (also called HAN), hydroxylamine sulfate (also called HAS), hydroxylamine phosphate, hydroxylamine hydrochloride and the like. In the etching liquid, an organic acid salt of a hydroxylamine may also be used, and examples thereof include hydroxylamine citrate and hydroxylamine oxalate. Among these salts of a hydroxylamine, inorganic acid salts such as hydroxylamine nitrate, hydroxylamine sulfate, hydroxylamine phosphate, and hydroxylamine hydrochloride are preferable since they are inactive toward a metal such as aluminum, copper, or titanium. In particular, hydroxylamine nitrate and hydroxylamine sulfate are preferable. With regard to these hydroxylamine compounds, one type thereof may be used on its own or two or more types may be used as a mixture.

The hydroxylamine compound is preferably contained at 0.1 to 15 mass % relative to the total mass of the etching liquid of the present embodiment, more preferably 6 to 15 mass %, and further preferably 3 to 8 mass %. When the content is adjusted to a value not more than the upper limit described above, it is preferable because a high etching rate can be retained. It is preferable that the content is adjusted to a value not less than the lower limit described above from the viewpoints of in-plane uniformity and long-term usability.

### (Alkali Compound)

The etching liquid of the present embodiment contains an alkali compound, and preferably contains an organic alkali compound. According to the present invention, the term “alkali compound” means to exclude the hydroxylamine compound described above, and there is no chance that a hydroxylamine compound is employed as the “alkali compound.” The alkali compound is preferably a basic organic compound. The basic organic compound preferably has carbon and nitrogen as constituent elements, and more preferably has an amino group. Specifically, the basic organic compound is preferably at least one compound selected from the group consisting of an organic amine and a quaternary ammonium hydroxide. The organic amine referred to here means an amine containing carbon as a constituent element.

The number of carbon atoms of the alkali compound is preferably 4 to 30, and from the viewpoint of boiling point and solubility in water more preferably 6 to 16.

The organic amine used as the organic alkali compound of the etching liquid of the present embodiment includes an alkanolamine such as monoethanolamine, diethanolamine, triethanolamine, diethylene glycolamine, or N-hydroxylethylpiperazine and/or an organic amine having no hydroxy group such as ethylamine, benzylamine, diethylamine, n-butylamine, 3-methoxypropylamine, tert-butyl amine, n-hexyl amine, cyclohexylamine, n-octylamine, 2-ethylhexylamine, o-xylylenediamine, m-xylylenediamine, 1-methyl butylamine, ethylenediamine (EDA), 1,3-propanediamine, 2-aminobenzylamine, N-benzylethylenediamine, diethylenetriamine, or triethylenetetramine. From the viewpoint of preventing corrosion of a metal, an organic amine having no hydroxy group is preferred over an alkanolamine. Furthermore, ethylenediamine, 1,3-propanediamine, o-xylylenediamine, and m-xylylenediamine are particularly preferable since they can coordinate to a metal. In the present specification, when a group (group of atoms) is denoted without specifying whether substituted or unsubstituted, the group includes both a group having no substituent and a group having a substituent. For example, an “alkyl group” includes not only an alkyl group having no substituent (unsubstituted alkyl group) but also an alkyl group having a substituent (substituted alkyl group).

The quaternary ammonium hydroxide used as the alkali compound is preferably a tetraalkylammonium hydroxide, and more preferably a tetraalkylammonium hydroxide substituted with a lower (1 to 4 carbon atom) alkyl group; specific examples thereof include tetramethylammonium hydroxide (TMAH), tetraethyl ammonium hydroxide (TEAH), tetrapropylammonium hydroxide (TPAH), tetrabutylammonium hydroxide (TBAH) and the like. Moreover, examples of the quaternary ammonium hydroxide include trimethylhydroxyethylammonium hydroxide (choline), methyltri (hydroxyethyl)ammonium hydroxide, tetra (hydroxyethyl)ammonium hydroxide, benzyltrimethylammonium hydroxide (BTMAH) and the like. In addition thereto, a combination of ammonium hydroxide and one or more quaternary ammonium hydroxides may also be used. Among them, TMAH, TEAH, TPAH, TBAH, and choline are more preferable, and TMAH and TBAH are particularly preferable.

With regard to these organic amines and quaternary ammonium hydroxides, one type thereof may be used on its own or two or more types may be used as a mixture.

The content of the alkali compound is preferably 3 to 25 mass % relative to the total mass of the etching liquid of the present embodiment, and more preferably 5 to 15 mass %. When the content is adjusted to a value not more than the upper limit and not less than the lower limit described above, it is preferable because a high etching rate can be retained. Note that, since the performance is saturated, even from this point of view, it is desirable that the content be maintained at or below the upper limit level.

### (Silicon Substrate Surface Treatment)

According to the present embodiment, it is preferable to further apply, in combination, a treatment for removing an oxide film that is naturally formed on the surface of the silicon substrate, and it is preferable to apply the oxide film removal treatment before the alkali compound and the hydroxylamine compound are applied. The method of surface treatment is not particularly limited as long as the method is capable of removing the oxide film formed on the silicon substrate surface, but for example, a method of treating the silicon substrate surface with an acidic aqueous solution containing fluorine atoms. The acidic aqueous solution containing fluorine atoms is preferably hydrofluoric acid, and the content of hydrofluoric acid is preferably about 0.1 to about 5 mass %, and more preferably 0.5 to 1.5 mass % relative to the total mass of the liquid of the present embodiment. When the content is adjusted to a value equal to or less than the upper limit, damage to members can be sufficiently suppressed, which is preferable. When the content is adjusted to a value equal to or more than the lower limit, removability of the oxide film can be sufficiently exhibited, and it is preferable. Furthermore, the hydrofluoric acid may also be present in the form of a salt.

(pH)

The silicon etching liquid of the present invention is alkaline, and is adjusted to pH 11 or more. This adjustment can be achieved by regulating the addition amounts of the alkali compound and the hydroxylamine compound. However, as long as the effects of the present invention are not impaired, the silicon etching liquid may be adjusted to a pH in the range described above by using another pH adjusting agent. The silicon etching liquid is preferably pH 12 or more. When this pH is equal to or more than the lower limit, a sufficient etching rate can be obtained. The upper limit of the pH is not particularly defined, but is practically 14 or less. The pH in the present invention is a value measured in the examples that will be described below.

### (Other Components)

Addition of Organic Solvent

The silicon etching liquid of the present invention may further contain a water-soluble organic solvent. It is effective from the viewpoint that uniform etchability in the plane of the wafer can be thereby further enhanced. Preferred examples of the water-soluble organic solvent include alcohol compounds (for example, ethylene glycol, glycerin, 1,3-propanediol, 1,3-butanediol, 1,4-butanediol, propylene glycol, furfuryl alcohol, and 2-methyl-2,4-pentanediol, diethylene glycol, dipropylene glycol, dipropylene glycol methyl ether, and propylene glycol monopropylene glycol), sulfoxide compounds (dimethyl sulfoxide and the like), and ether compounds (for example, ethylene glycol dimethyl ether, diethylene glycol dimethyl ether, triethylene glycol dimethyl ether, tetraethylene glycol dimethyl ether, and propylene glycol dimethyl ether). Furthermore, compounds having a combination of hydroxyl group (—OH), ether group (—O—) and sulfoxide group (—SO₂—) in one molecule thereof may be used. In that case, they may be classified into one of alcohol compounds, sulfoxide compounds or ether compounds. The addition amount is preferably 0.1 to 20 mass %, and more preferably 1 to 15 mass % relative to the total amount of the etching liquid. When this amount is equal to or more than the lower limit, an enhancement in the uniformity of etching can be effectively realized. On the other hand, when the addition amount is equal to or less than the upper limit, wettability to a polycrystalline silicon film, an amorphous silicon film, or other metal films can be secured.

### Addition of Surfactant

The silicon etching liquid of the present invention may further contain a surfactant. As the surfactant, nonionic, anionic, cationic, and amphoteric surfactants may be used. The content of the surfactant in the silicon etching liquid is preferably 0.0001 to 5 mass %, and more preferably 0.0001 to 1 mass % relative to the total mass of the silicon etching liquid. By adding the surfactant to the silicon etching liquid, the viscosity of the silicon etching liquid can be adjusted, and the in-plane uniformity of etching can be further improved, which is preferable. Such a surfactant is generally commercially available. These surfactants may be used singly, or plural kinds may be used in combination.

Examples of the nonionic surfactant include a polyalkylene oxide alkyl phenyl ether-based surfactant, a polyalkylene oxide alkyl ether-based surfactant, a polyethylene oxide/polypropylene oxide block polymer-based surfactant, a polyoxyalkylene distyrenated phenyl ether-based surfactant, a polyalkylene tribenzyl phenyl ether-based surfactant, and an acetylene polyalkylene oxide-based surfactant.

Examples of the anionic surfactants include alkyl sulfuric acid esters, alkyl sulfonic acid, alkyl benzenesulfonic acid, alkyl naphthalenesulfonic acid, alkyl diphenyl ether sulfonic acid, polyoxyethylene alkyl ether carboxylci acid, polyoxyethylene alkyl ether acetic acid, polyoxyethylene alkyl ether propionic acid, and salts thereof.

Examples of the cationic surfactants include quaternary ammonium salt-based surfactants and alkylpyridium-based surfactants.

Examples of the amphoteric surfactants include betaine type surfactants, amino acid type surfactants, imidazoline type surfactants, and amine oxide type sufactants.

### (Object to be Processed)

The material that is etched by applying the etching liquid of the present embodiment may be any material, but as a substrate material generally used in the production of capacitors, polycrystalline silicon or amorphous silicon may be used. On the other hand, an example of the electrode material constituting the core of the capacitor structure may be titanium nitride (TiN). That is, the etching liquid of the present embodiment is preferably such that the ratio of the etching rate of the substrate material (ERs) and the etching rate of the electrode material (ERe), (ERs/ERe) is high. The specific value of the ratio is dependent on the type or structure of the material and is not particularly limited. However, the ratio ERs/ERe is preferably 100 or more, and more preferably 200 or more. In the present specification, use of the etching liquid so as to etch a silicon substrate is referred to as “application,” but the embodiment is not particularly limited. For example, batch type etching may be carried out through immersion, or sheet type etching may also be carried out through discharge.

There are no particular limitations on the shape or dimension of the capacitor structure to be processed; however, to take an example of a capacitor structure having a cylindrical structure as described above, when the aspect ratio of the cylinder bore is 5 or more, the superior effect of the etching liquid of the present embodiment is particularly appropriately exhibited, and thus it is preferable. From a similar viewpoint, the aspect ratio (depth/width) is preferably 15 or more, and more preferably 20 or more. The opening diameter d of the cylinder bore is not particularly limited, but from the viewpoint of allowing the effect of the present embodiment to be manifested and considering the recent tendency for micronization of capacitor structures, the opening diameter is preferably 20 to 80 nm.

Furthermore, an emphasis should be placed herein on that according to the present invention, uniform etchability of the capacitor structure is realized at the edges and the center of a wafer. To explain this in terms of the etching rate, the ratio of the etching rate at the edges, Re, and the etching rate at the center, Rc, (Rc/Re), is preferably 0.7 to 1.5, and more preferably 0.85 to 1.15. Thereby, the production of capacitors as recently demanded can contribute to the realization of a balance between high manufacturing quality and high production efficiency, and therefore, it is preferable.

### EXAMPLES

The present invention will be described in more detail based on examples given below, but the invention is not meant to be limited by these.

### Example 1 and Comparative Example 1

Etching liquids were prepared by incorporating the components indicated in the following Table 1 at the composition (mass %) indicated in the following formulations.

### <Etching Test>

Test wafer: A wafer having a polycrystalline silicon film having a thickness of 500 nm or an amorphous silicon film having a thickness of 500 nm formed on monocrystal <100> silicon, was provided. This wafer was subjected to etching using a sheet type etching apparatus (POLOS (trade name), manufactured by SPS-Europe B.V.) under the following conditions, and an evaluation test was carried out. A wafer having a diameter of 300 mm was used, and an evaluation was made by making a comparison between the etching rate at a site on the circumference of a concentric circle having a radius of 10 mm from the center (etching rate at center, Rc) and the etching rate at a site 30 mm away from the edge (Re).

Reagent liquid temperature: 80° C.

Amount discharged: 1 L/min

Speed of rotation of wafer: 500 rpm

The results of the above test are graded according to the following criteria and presented in the table.

### [Etching Rate for Amorphous Silicon]

B: less than 300 nm/min
A: 300 nm/min or more, less than 500 nm/min
AA: 500 nm/min or more

### [Etching Rate for Polycrystalline Silicon]

B: less than 700 nm/min
A: 700 nm/min or more, less than 1000 nm/min
AA: 1000 nm/min or more

The pH as indicated in the table is a value measured at room temperature (20° C.) using F-51 (trade name) manufactured by Horiba, Ltd.

TABLE 1

| | Alkali compound (a) | | Hydroxylamines (b) | | | | |
|---|---|---|---|---|---|---|---|
| | Kind of | | Kind of | | | | |
| | compound | (mass %) | compound | (mass %) | Water | pH | Type of wafer |
| Example 1 | TMAH | 25 | Hydroxylamine sulfate | 16 | balance | 12.2 | Amorphous |
| Example 2 | TMAH | 7 | Hydroxylamine | 8 | balance | 13.2 | Amorphous |
| Example 3 | TMAH | 8 | Hydroxylamine | 5 | balance | 13.4 | Amorphous |
| Example 4 | TMAH | 8 | Hydroxylamine | 2 | balance | 12.8 | Polycrystalline |
| Example 5 | KOH | 10 | Hydroxylamine sulfate | 10 | balance | 13.7 | Amorphous |
| Example 6 | TMAH | 15 | Hydroxylamine | 12 | balance | 12.2 | Amorphous |
| | | | Hydrochloride | | | | |
| Example 7 | TBAH | 4 | Hydroxylamine | 6 | balance | 12.1 | Amorphous |
| Example 8 | TMAH | 8 | Hydroxylamine | 6 | balance | 13.2 | Polycrystalline |
| Example 9 | TMAH | 10 | Hydroxylamine | 4 | balance | 13.4 | Amorphous |
| Example 10 | TMAH | 10 | Hydroxylamine | 10 | balance | 13.8 | Amorphous |
| Example 11 | TMAH | 5 | Hydroxylamine sulfate | 1 | balance | 12.8 | Amorphous |
| Example 12 | TMAH | 10 | Hydroxylamine | 11 | balance | 13.4 | Polycrystalline |
| Example 13 | TMAH | 13 | Hydroxylamine | 3 | balance | 13.6 | Amorphous |
| Example 14 | NH₃ | 15 | Hydroxylamine | 3 | balance | 12.7 | Polycrystalline |
| Example 15 | TMAH | 14 | Hydroxylamine sulfate | 8 | balance | 13.1 | Polycrystalline |
| Example 16 | TMAH | 7 | Hydroxylamine | 8 | balance | 13.2 | Amorphous |
| Example 17 | TMAH | 8 | Hydroxylamine | 6 | balance | 13.2 | Polycrystalline |
| Comparative example 1 | TMAH | 2 | — | — | balance | 12.5 | Amorphous |
| Comparative example 2 | — | — | Hydroxylamine | 5 | balance | 11.3 | Amorphous |
| Comparative example 3 | — | — | Hydroxylamine sulfate | 10 | balance | 3.0 | Amorphous |
| Comparative example 4 | TMAH | 5 | — | — | balance | 12.9 | Polycrystalline |
| Comparative example 5 | — | — | Hydroxylamine | 10 | balance | 11.8 | Polycrystalline |
| Comparative example 6 | TMAH | 8 | Hydroxylamine sulfate | 8 | balance | 7.8 | Polycrystalline |
| Comparative example 7 | TMAH | 5 | Hydroxylamine sulfate | 10 | balance | 7.4 | Amorphous |

| | Etching rate for silicon at | Etching rate at center after | Etching rate for silicon |
|---|---|---|---|
| | center | 2 hours | at edge |
| Example 1 | AA | AA | A |
| Example 2 | AA | AA | AA |
| Example 3 | AA | AA | AA |
| Example 4 | A | A | A |
| Example 5 | AA | AA | AA |
| Example 6 | AA | AA | AA |
| Example 7 | AA | AA | AA |
| Example 8 | AA | AA | AA |
| Example 9 | AA | AA | AA |
| Example 10 | AA | AA | AA |
| Example 11 | A | A | A |
| Example 12 | AA | AA | AA |
| Example 13 | AA | AA | AA |
| Example 14 | AA | AA | AA |
| Example 15 | AA | AA | AA |
| Example 16 | AA | AA | AA |
| Example 17 | AA | AA | AA |
| Comparative example 1 | B | B | B |
| Comparative example 2 | B | B | B |
| Comparative example 3 | B | B | B |
| Comparative example 4 | B | B | B |
| Comparative example 5 | B | B | B |
| Comparative example 6 | B | B | B |
| Comparative example 7 | B | B | B |

Note)
In Table 1, Etching rate at center after 2 hours: the results, that the etching liquid was prepared liquid, and then after completion of still standing for 2 hour, the wafers were subjected to etching, are presented.

As can be seen in the above table, it is understood that when the silicon etching liquid of the present invention is used, sufficient etching rates can be realized especially for amorphous silicon and polycrystalline silicon, and an etching treatment having no difference between the edges and the center of a wafer can be achieved. Furthermore, it is clearly seen that the etching liquid has excellent storage properties so that a good balance between productivity and manufacturing quality in the capacitor production can be realized. It was also confirmed that the silicon etching liquid of the present invention has minimal damage to various films of TiN, SiN, SiO₂ and the like, which are electrode materials of elements.

In regard to the silicon etching liquid of Comparative Examples, it was difficult to achieve a balance in the etching rate between the center and the edge of a wafer, and there was a tendency that particularly, the rate at the edge is decreased to a large extent. Specifically, in regard to the ratio of rate at the center with respect to the rate at the edge, the ratio of Comparative Example 2 was 1.8 times, the ratio of Comparative Example 5 is 1.35 times, and the ratio of Comparative Example 6 was 1.5 times. On the contrary, according to the present invention, etchability that is improved to a large extent as compared with the Comparative Examples can be realized in an enhanced manner for both the center and the edge.

### Example 2 and Comparative Example 2

Reagent liquids were prepared by adding 10 mass % of the various solvents indicated in the following Table 2, in addition to 10 mass % of TMAH and 5 mass % of hydroxylamine (All reagent liquids were pH 12 or more.). An etching test (measurement of the rate at 10 mm from the center) was carried out in the same manner as in Example 1, using the etching liquids thus obtained. Furthermore, the contact angles of silicon and TiN were measured at room temperature. These results are presented in the following Table 2.

TABLE 2

| | Etching rate | Contact angle | Etching rate | Contact angle | Contact angle |
|---|---|---|---|---|---|
| | for polycrystalline Si | of polycrystalline Si | for amorphous Si | of amorphous Si | of TiN |
| Solvent | (80° C., nm/min.) | (°, 20° C.) | (80° C., nm/min.) | (°, 20° C.) | (°, 20° C.) |
| Ethylene glycol | 1500 | 42.7 | 680 | 50.2 | 11.4 |
| Dimethylsulfoxide | 1250 | 42.6 | 530 | 50.3 | 15.0 |
| Dipropylene glycol | 750 | 15.6 | 450 | 18.2 | 11.0 |
| 1,4-Butanediol | 1100 | 34.6 | 630 | 40.9 | 11.7 |
| Diethylene glycol | 200 | 12.4 | 170 | 14.6 | 10.7 |
| dimethyl ether | | | | | |
| No solvent | 1800 | 45 | 850 | 54.5 | 28.9 |

As it can be seen from the above results, the etching liquids to which a solvent was added had decreased contact angles as compared with the etching liquids to which a solvent was not added, and an enhancement of wettability could be confirmed. That is, since an enhancement of wettability was recognized, it can be speculated that silicon residue is not easily generated in the capacitor. In addition, an improvement in the removability of such silicon residue brings about a synergistic effect, and can significantly contribute to a balance between uniform etchability in a wafer and an enhancement of the etching rate, as confirmed in Example 1.

Furthermore, in the etching liquids to which a solvent was added, less silicon residue could be produced, and higher yields could be obtained in a test on a wafer with capacitor structures, as compared with the etching liquids without solvent.

Having described our invention as related to the present embodiments, it is our intention that the invention not be limited by any of the details of the description, unless otherwise specified, but rather be construed broadly within its spirit and scope as set out in the accompanying claims.

### REFERENCE SIGNS LIST

1: first insulating film
2: second insulating film
3: silicon wafer
4: photoresist
5: conductive film
6: embedded film
9: capacitive insulating film
10, 20: capacitor structure
50: lower electrode (cylinder wall)

1. A method of forming a capacitor structure, which comprises: applying a silicon etching liquid which contains an alkali compound and a hydroxylamine compound in combination, with the pH adjusted to 11 or more, to a polycrystalline silicon film or an amorphous silicon film, removing a part or all of the polycrystalline silicon film or amorphous silicon film, and forming concave and convex shapes that constitute a capacitor.

2. The method according to claim 1, wherein the area with the concave and convex shapes has a cylinder bore that is formed as a result of removal of the silicon film using the silicon etching liquid.

3. The method according to claim 1, further comprising a step of removing an oxide film formed on the silicon film before the silicon etching liquid is applied.

4. The method according to claim 2, wherein the area with the concave and convex shapes that constitute the capacitor structure includes TiN, and the cylinder bore has an aspect ratio of 15 or more.

5. The method according to claim 1, wherein the concentration of the alkali compound is 3 to 25 mass %.

6. The method according to claim 1, wherein the concentration of the hydroxylamine compound is 0.1 to 15 mass %.

7. The method as set forth in claim 1, wherein the silicon etching liquid further contains alcohol compounds, sulfoxide compounds or ether compounds.

8. A silicon etching liquid for preparing a capacitor structure by removing a part or all of a polycrystalline silicon film or an amorphous silicon film to shape concave and convex shapes that constitute a capacitor, which comprises an alkali compound and a hydroxylamine compound in combination, with the pH adjusted to 11 or more.

9. The silicon etching liquid according to claim 8, wherein the object of application is a polycrystalline silicon film.

10. The silicon etching liquid according to claim 8, wherein the object of application is an amorphous silicon film.

11. The silicon etching liquid according to claim 8, wherein the area with the concave and convex shapes that constitute the capacitor structure includes TiN, and has a cylinder bore that is formed as a result of removal of the silicon film using the silicon etching liquid.

12. The silicon etching liquid according to claim 11, wherein the cylinder bore has an aspect ratio of 15 or more.

13. The silicon etching liquid according to claim 8, wherein the concentration of the alkali compound is 3 to 25 mass %.

14. The silicon etching liquid according to claim 8, wherein the concentration of the hydroxylamine compound is 0.1 to 15 mass %.

15. The silicon etching liquid according to claim 8, wherein the alkali compound is one or more compounds selected from quaternary ammonium hydroxides, ammonia and potassium hydroxide.

16. The silicon etching liquid according to claim 8, wherein the alkali compound is a quaternary ammonium hydroxide.

17. The silicon etching liquid according to claim 8, wherein the alkali compound is tetramethylammonium hydroxide.

18. The silicon etching liquid according to claim 8, wherein the silicon etching liquid is used immediately after a treatment for removing the oxide film formed on the surface of the silicon film.

19. The silicon etching liquid as set forth in claim 8, wherein the silicon etching liquid further contains alcohol compound, sulfoxide compound or ether compound.
